(19) United States
(12) Patent Application Publication
(10) Pub. No.: US 2005/0167347 A1
(43) Pub. Date: Aug. 4, 2005

(54) Ornamental waterfall

(76) Inventor: Charles W. Thomas, Birmingham, AL (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 10/772,015

(22) Filed: Feb. 4, 2004

(51) Int. Cl. A01K 63/04; B01D 24/22

(52) U.S. Cl. 210/170; 210/167; 210/416.1

(57) ABSTRACT

A decorative aquatic aeration system as found in residential gardens or the like having: an impervious liner defining a sump and confining a quantity of water, a skimmer basin located within the sump adapted to receive surface water into the basin from the pond, a catch net disposed within the skimmer basin, a cover affixed over a major portion of the catch basin, a bottom drain disposed along the bottom of the sump, a quantity of filter rock filling the pond externally of the basin and overlying the cover and the perforated conduit, and a submersible pump housed within the basin and pumping water from the basin and the perforated conduit to a aerated return path to the sump. Aquatic plants are rooted in the filter rock to aid in processing the water drawn through the rocks into the pump.

### CROSS REFERENCE TO RELATED APPLICATIONS

This application claims priority from Provisional Patent Application No. 60/400,596, filed on Aug. 2, 2002. and Non-Provisional Utility Patent Application Ser. No. 10/628,851 filed on Jul. 27, 2003.

### FIELD OF THE INVENTION

The present invention relates to the field of decorative waterfalls or artificial ponds with such waterfalls as a means of aeration. More particularly the present invention relates to filtration systems for such systems. In even greater particularity the present invention relates to a structure and method for purifying water in an aquatic environment which requires little maintenance or labor to remove filtrate material

### BACKGROUND OF THE INVENTION

The provision of ornamental waterfalls and aquatic gardens is a multi-million dollar industry. Likewise, the maintenance of such systems is also a multimillion dollar industry. Numerous variations on aquatic system set up exist, however, it is common to utilize pumps and artificial filter material to establish a water flow and filter the water to maintain a life sustaining level of clarity and an aesthetically pleasing appearance to the water. Some developers have suggested using natural filter material such as gravel or rock in the bottom of such ornamental ponds, however, such usage requires significant labor when the gravel bed becomes loaded and needs to be cleaned. What is needed is a perpetual system requiring minimal cleaning and replacement of filtration materials.

### SUMMARY OF THE INVENTION

The present invention is used in a decorative aquatic waterfall as found in residential gardens or the like having an impervious liner defining a sump and confining a quantity of water for use in the waterfall, a filtration system comprising a skimmer basin located within the secondary sump and adapted to receive surface water into the basin from the sump, a catch net disposed within the skimmer basin, a cover affixed over a major portion of the catch basin, a bottom drain disposed along the bottom of the sump, a quantity of filter rock filling the sump externally of the basin and overlying the cover and the perforated conduit, and a pump in communication with the basin and pumping water from the basin and the perforated conduit to a return path to the sump via a decorative waterfall. Aquatic plants are rooted in the filter rock to aid in processing the water drawn through the rocks into the pump.

### BRIEF DESCRIPTION OF THE DRAWINGS

An aquatic ornamental waterfall system is depicted in the Figures which form a portion of this disclosure and wherein:

FIG. 1 is a perspective view of the system, showing submerged or buried components in dotted line;

FIG. 2 is a plan view of the system; and,

FIG. 3 is a sectional view of the catch basin from one side 2.

FIG. 4 is a second plan view; and

FIG. 5 is a sectional to the secondary pool.

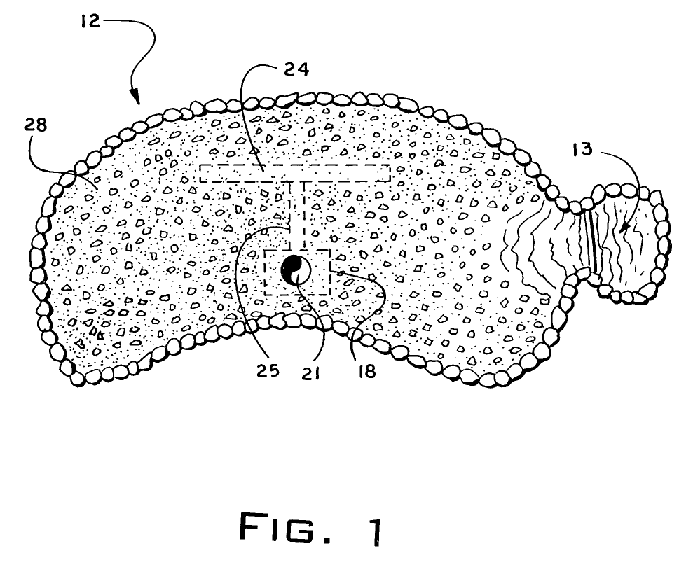

### DESCRIPTION OF THE PREFERRED EMBODIMENT

Ornamental waterfalls are generally located by choice rather than by natural occurrence, thus it should be understood that construction of the waterfall in accordance with this invention usually requires excavation of a depression in which the water will be contained. Of course a natural depression could be used if conveniently available. Containment is generally accomplished by use of a pervious liner 11 which conforms to the depression or which is molded to give a desired shape to the sump 12. The pervious liner 11 is well known in the art as is the manner of placing the liner in the sump 12. A decorative rock wall generally overlies the liner about the edges of the system to hold the liner 11 in place although such is not necessary.

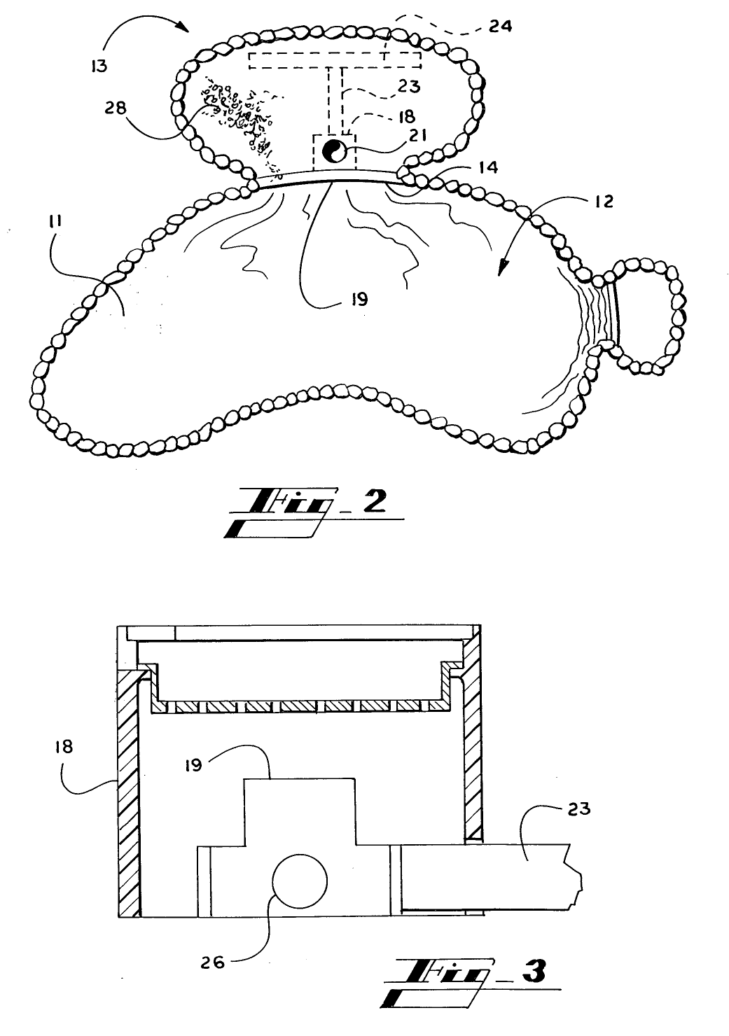

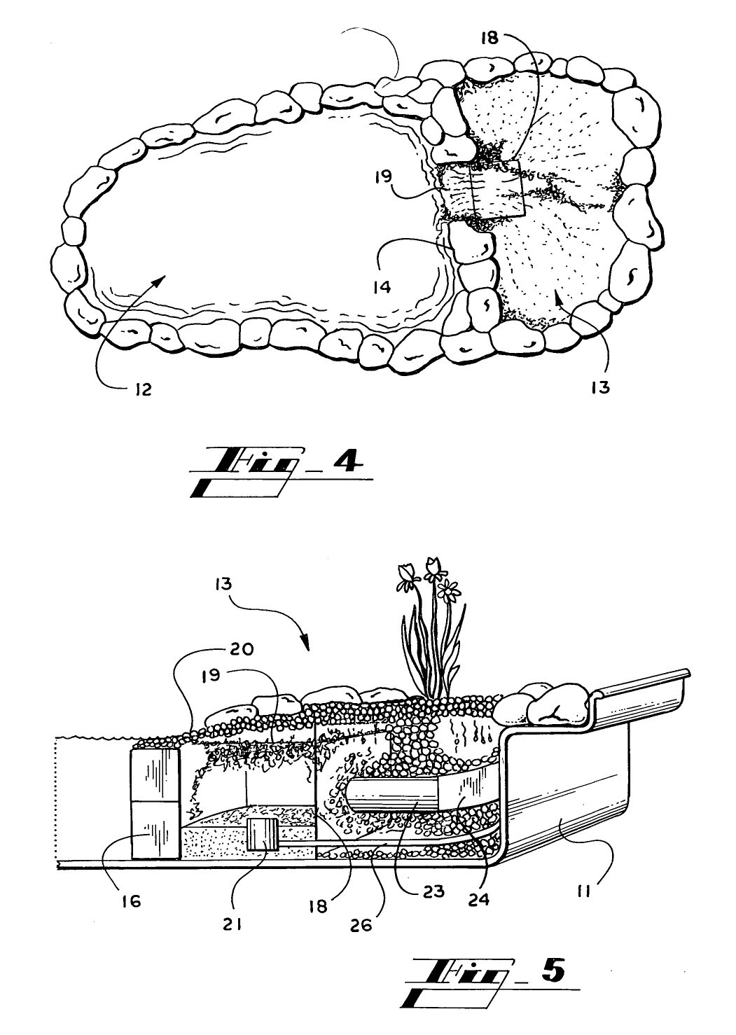

As seen more clearly in FIG. 2, situated within sump 12 is a preformed catch basin 18 made of a suitable molded plastic. Referring to FIG. 3 it may be seen that catch basin 18 has a skimmer channel 19 along an upper margin thereof facing the pond such that water can pass directly from the surface of the pond 12 into the catch basin. Suspended from the upper margin of the basin is a net 17 or skimmer basket through which water from the pond may pass and which serves as a guard to catch larger debris. Within the basin 18 is a submersible pump 21 which includes a first inlet 22 for receiving water entering the basin 18 via skimmer channel 19. It will be appreciated that the pump may also be external to the basin 18 and simply have an intake to draw water from the basin. In either case, the pump also has a second inlet, which may be combined with the first inlet in practice for receiving water from externally of the basin 18 via a conduit 23 which communicates through the wall of basin 18 with the sump 12. Conduit 23 is attached to an extended receiver 24 positioned along the bottom of sump 12 distal basin 18.. Conduit 23 may extend from the back or side of basin 18.

A discharge outlet 26 on pump 21 passes from basin 18 and out of sump 12 to a point for recirculation of water to a waterfall 13 which in turn discharges the water onto the rocks filling sump 12. The basin 18 is partially covered by a top 20 which does not interfere with skimmer channel 19 and which helps to secure the catch net 17 or skimmer basket. The catch net 17 may have a rigid stiffener about its margin to interact with the basin walls and top 20 for proper securement.

Sump 12 is filled to a level one inch or so above the water level in the system with filter 28 material which is preferably No. 57 pea gravel, or any other non reactive rock suitable for use in an aqueous environment having irregular shapes and measuring between about one-half to two inches in any dimension. Other examples of suitable rock, including lava rock will come to mind, however it is to be understood that any non reactive rock which will provide sufficient interstitial space for water passage and particulate filtration would be suitable. The spacing and density of the rock should also accommodate the growth of root systems for plants to be planted in the filter material such that natural removal of the nutrient material in the water being filtered can occur. It will be appreciated that receiver 24 is covered over by the filter material which also overlies the basin top 20 so that the sump has the appearance of a rock bed or bog area with vegetation growing out of the filter material in the same manner as vegetation grows out of the areas adjacent a naturally occurring pond.

In operation, the sump is filled with water which fills the interstices of the filter material in the sump and flows over the skimmer channel into the basin. Activation of the pump draws water out of the basin and into the receiver through the filtration material such that particulate filtration occurs in the bog. The water from these sources is discharged by the pump into a recirculation path such as an artificial waterfall or geyser which aerates the water before it returns to the sump. Plants in the bog and anaerobic bacteria provide further natural recycling of the particulate and organic material brought into the bog by the flow of the water to the pump. Accordingly, the system may also be associated with a pond area which may be utilized for decorative plants, lights, fish, and structures in a clear water environment, without any significant accumulation of debris or particulate matter in the pond.

Thus, although there have been described particular embodiments of the present invention of a new and useful ornamental waterfall, it is not intended that such references be construed as limitations upon the scope of this invention except as set forth in the following claims.

1. In a decorative aquatic waterfall as found in residential gardens or the like having an impervious liner defining a sump and confining a quantity of water within the sump, a filtration system comprising:
a skimmer basin located within said sump and adapted to receive surface water into said basin from the sump;
a debris guard within said skimmer basin;
a cover affixed over a major portion of said skimmer basin;
a perforated conduit disposed along the bottom of said sump;
a quantity of filter rock filling said sump externally of said basin and overlying said cover and said perforated conduit; and
a pump in communication with said basin and pumping water from said basin and said perforated conduit to a airative return path to the sump.

2. The filtration system as defined in claim 1 wherein said return path is via an artifical waterfall.

3. The filtration system as defined in claim 1 wherein said return path comprises a fountain disposed above said sump.

4. The filtration system as defined in claim 1 wherein said filter rock is sized such that living aquatic plants may be rooted therein.

5. The filtration system as defined in claim 1 further comprising hydroponic plants rooted in said filter rock.

6. The filtration system as defined in claim 1 wherein said filter rock is dimensionally larger than any apertures in said perforated conduit.

7. The filtration system as defined in claim 1 wherein said skimmer basin includes a rigid support for said catch net.

8. A filtration system for an ornamental system containing water comprising:
a skimmer basin in sump containing said water having an inlet at the surface of the water therein;
a pump in communication with said skimmer basin having an intake from the bottom of said sump and an outlet discharging to an aeration device; and
natural filtration media filling said secondary pool above water level and surrounding said skimmer basin.

9. A filtration system as defined in claim 8 wherein said natural filtration media comprises a plurality of non-reactive rocks having at least one aquatic plant rooted therein.

10. A filtration system as defined in claim 9 wherein said aeration device is an artificial waterfall.

11. A filtration system as defined in claim 9 wherein said aerator is a fountain.

12. A filtration system as defined in claim 8 including a debris guard disposed within said skimmer basin above said pump intake.
